(19) United States
(12) Patent Application Publication
(10) Pub. No.: US 2025/0258275 A1
(43) Pub. Date: Aug. 14, 2025

(54) SYSTEM FOR MUITIPLE RADARS AND OPERATION METHOD THEREOF

(71) Applicant: ELECTRONICS AND TELECOMMUNICATIONS RESEARCH INSTITUTE, Daejeon (KR)

(72) Inventors: PIL JAE PARK, Daejeon (KR); Duck Hwan KIM, Daejeon (KR)

(21) Appl. No.: 18/918,825

(22) Filed: Oct. 17, 2024

(30) Foreign Application Priority Data
Feb. 8, 2024 (KR) 10-2024-0019361

(51) Int. Cl. G01S 7/03; G01S 7/02; G01S 13/10

(52) U.S. Cl. CPC G01S 7/032; G01S 7/0235; G01S 13/106

(57) ABSTRACT

A radar system includes a first radar that generates a first transmit pulse in response to a first transmission clock signal and detects a target in response to the first transmission clock signal and a first reception clock signal with a first transmission clock and reception clock signal time difference according to a first detection distance and a second radar that generates a second transmit pulse in response to a second transmission clock signal and detects the target in response to the second transmission clock signal and a second reception clock signal with a second transmission clock and reception clock signal time difference according to a second detection distance. The first and the second transmission clock signals are not synchronous with each other. The first radar generates a minimum detection distance notification, when the first detection distance is a minimum detection distance detected by the first radar.

### CROSS-REFERENCE TO RELATED APPLICATION(S)

This application claims priority under 35 U.S.C. § 119 to Korean Patent Application No. 10-2024-0019361 filed on Feb. 8, 2024, in the Korean Intellectual Property Office, the disclosures of which are incorporated by reference herein in their entireties.

### BACKGROUND

### 1. Field of the Invention

Embodiments of the present disclosure described herein relate to a radar apparatus and a radar system, and more particularly, relate to a system for multiple radars and an operation method thereof.

### 2. Description of Related Art

A clock-based radar may generate and radiate a transmit signal in response to a clock signal and may receive a response signal originated by the transmit signal, in response to the clock signal. Such a clock-based radar may obtain a distance between the radar and target, with regard to a time difference between a transmission clock signal and a reception clock signal, a speed of a radiated pulse, and the like.

As it is difficult to detect all of target(s) using only a single radar, a radar system including multiple radars may be constructed for multiple targets. As another example, the radar system including the multiple radars may be constructed to improve the accuracy of detection for a target (or, targets). There is a need for an apparatus, a method, and a system capable of suppressing deterioration in detection performance of each of radars due to interference generated by mutual transmit signals between the multiple radars in such a radar system.

### SUMMARY

Embodiments of the present disclosure provide a radar system for minimizing an interfering signal between multiple radars and optimizing the detection performance of an individual radar of the radar system and an operation method thereof.

According to an embodiment, a radar system may generate a first transmit pulse in response to a first transmission clock signal. A first radar may be configured to detect a target in response to the first transmission clock signal and a first reception clock signal having a clock delay between the transmission clock signal and the reception clock signal according to a first detection distance. A second radar may be configured to generate a second transmit pulse in response to a second transmission clock signal and detect the target (targets) in response to the second transmission clock signal and a second reception clock signal having a clock delay between the transmission clock signal and the reception clock signal according to a second detection distance. The first transmission clock signal and the second transmission clock signal may not operate in synchronous with each other. The first radar may generate a minimum detection range notification signal, when the first detection distance is a minimum detection distance detected by the first radar.

In an embodiment, the radar system may further include a third radar. The third radar may generate a third transmit pulse in response to a third transmission clock signal. The third radar may detect the target in response to the third transmission clock signal and a third reception clock signal having a clock delay between transmission and reception clock signal according to a third detection distance. The third transmission clock signal may not be synchronous with the first transmission clock signal and the second transmission clock signal.

In an embodiment, a first center frequency of the first transmit pulse and a second center frequency of the second transmit pulse may be different from each other

In an embodiment, the first transmission clock signal may include a first rising edge and a second rising edge. An interval between the first rising edge and the second rising edge may be an arbitrary interval between a first interval and a second interval. The second transmission clock signal may include a third rising edge and a fourth rising edge. An interval between the third rising edge and the fourth rising edge may be an arbitrary interval between a third interval and a fourth interval.

In an embodiment, the first detection distance may be a distance between a minimum detection distance and a maximum detection distance of the radar system. The second detection distance may be a distance between the minimum detection distance and the maximum detection distance of the radar system.

In an embodiment, the first radar may include a receiver unit. The configuration of the receiver unit may be as follows. A receive antenna may be configured to receive an echo signal generated after the transmit pulse is reflected from the t target. A low-noise amplifier may be configured to amplify the echo signal to generate a first receive signal. A wide band sampler may be configured to receive the first receive signal and sample the first receive signal in response to a reception clock signal to generate a second receive signal. A data processor may be configured to generate receive data, based on the second receive signal.

In an embodiment, the first interval and the second interval may be generated based on a first period and a first variable period. The third interval and the fourth interval may be generated based on a second period and a second variable period. The first interval may be a value obtained by subtracting the first variable period from the first period, and the second interval may be a value obtained by adding the first variable period to the first period. The third interval may be a value obtained by subtracting the second variable period from the second period, and the fourth interval may be a value obtained by adding the second variable period to the second period.

In an embodiment, the receiver unit may further include a baseband amplifier configured to amplify a baseband of the second receive signal to generate a third receive signal. The data processor may include an analog-digital converter (ADC) configured to convert the third receive signal into a digital signal and the digital signal is configured to form a scan vector. The scan vector generates a scan matrix. The scan matrix may be saved in a memory . . .

In an embodiment, the scan vector and the scan matrix may be generated in response to the minimum detection distance notification.

According to an embodiment, an operation method of a radar system for detecting a t target may include a first detection stage by means of a first radar based on a first transmission clock signal. The operation may include a second detection stage by means of a second radar based on a second transmission clock signal. The operation may further include detection stages in which the first radar and the second radar detect targets from a minimum detection distance of each of the first radar and the second radar to a maximum detection distance of each of the first radar and the second radar. The first transmission clock signal and the second transmission clock signal may not be synchronous with each other.

In an embodiment, the first radar may detect the target in response to the first transmission clock signal and a first reception clock signal with a first transmission clock and reception clock signal time difference according to a first detection distance. The second radar may detect the target in response to the second transmission clock signal and a second reception clock signal with a second transmit and reception clock signal time difference according to a second detection distance.

In an embodiment, the first transmission clock signal may include a first rising edge and a second rising edge. An interval between the first rising edge and the second rising edge may be an arbitrary between a first interval and a second interval. The second transmission clock signal may include a third rising edge and a fourth rising edge. An interval between the third rising edge and the fourth rising edge may be an arbitrary between a third interval and a fourth interval.

The first interval and the second interval may be generated based on a first period and a first variable period, and the third interval and the fourth interval may be generated based on a second period and a second variable period. The first interval may be a value obtained by subtracting the first variable period from the first period, and the second interval may be a value obtained by adding the first variable period to the first period. The third interval may be a value obtained by subtracting the second variable period from the second period, and the fourth interval may be a value obtained by adding the second variable period to the second period.

According to an embodiment, a radar configured to detect a target may include the following function units. A control unit may be configured to control an operation of the radar. A transmitter unit may be configured to radiate a transmit pulse to the target, in response to a transmission clock signal. A receiver unit may be configured to receive an echo signal reflected from the target in response to a reception clock signal and generate detection data. A clock generation unit may be configured to generate the transmission clock signal and the reception clock signal. The transmission clock signal may include a first rising edge and a second rising edge. An interval between the first rising edge and the second rising edge may be a first interval obtained by subtracting a first variable period from a first period to a second interval obtained by adding the first variable period to the first period.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a radar system according to an embodiment of the present disclosure;

FIG. 2 is a block diagram illustrating in detail a radar included in a radar system of FIG. 1;

FIG. 3 is a graph illustrating a change in transmission clock signal and reception clock signal of each of a plurality of radars over time, according to an embodiment of the present disclosure;

FIG. 4 is a graph illustrating a change in transmit and reception clock signal time difference of FIG. 3 over time, according to an embodiment of the present disclosure;

FIG. 5 is a table illustrating a transmit interval between rising edges of a transmission clock signal of each of radars included in a radar system of FIG. 1, according to an embodiment of the present disclosure;

FIG. 6 is a block diagram illustrating in detail a clock generation unit of FIG. 2, according to an embodiment of the present disclosure;

FIG. 7 is a block diagram illustrating in detail a transmitter unit, according to an embodiment of the present disclosure;

FIG. 8 is a table illustrating a center frequency of a transmit pulse generated by a transmitter unit and a transmission clock signal frequency, according to an embodiment of the present disclosure;

FIG. 9 is a block diagram illustrating in detail a receiver unit, according to an embodiment of the present disclosure; and

FIG. 10 is a flowchart illustrating an operation method of a radar system described with reference to FIGS. 1 to 9, according to an embodiment of the present disclosure.

### DETAILED DESCRIPTION

Hereinafter, embodiments of the present disclosure will be described clearly and in detail to such an extent that those skilled in the art easily carry out the present disclosure.

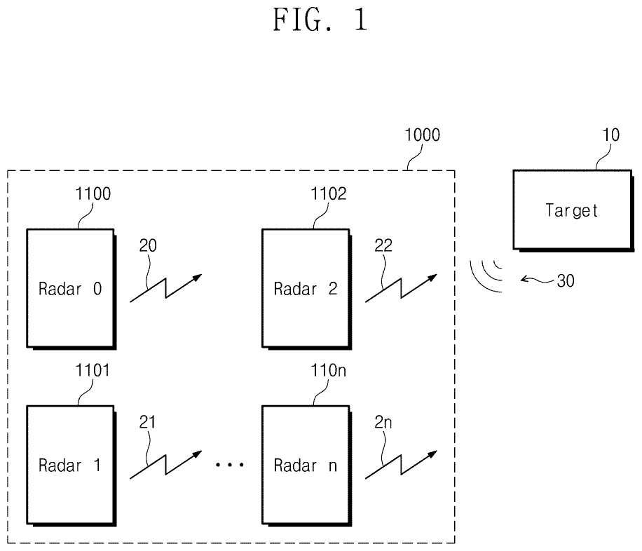

FIG. 1 is a block diagram illustrating a radar system, according to an embodiment of the present disclosure. Referring to FIG. 1, a radar system 1000 may include a plurality of radars 1100 to 110n. Each of the plurality of radars 1100 to 110n may include the 0th radar 1100 and first to nth radars 1101 to 110n. The radar system 1000 according to an embodiment of the present disclosure will be described in detail with reference to FIG. 1.

The radar system 1000 may be a system for finding a target 10. For example, the use of the radar system 1000 may vary. For example, the radar system 1000 may be included in systems of various uses, such as a system for detecting a person in indoor, a system for navigation device, a military system, or a fish detection system. In an embodiment, the radar system 1000 may be a system which operates based on a clock. The target 10 may be a target to be detected by the radar system 1000, which may be another target depending on the purpose of the radar system 1000. For example, when the radar system 1000 is the military system, the target 10 may be equipment, a radar, or the like of an ally or an enemy.

Each of the radars 1100 to 110n may detect the target 10. In an embodiment, the radars 1100 to 110n may independently detect the target 10. For example, the first radar 1101 may detect the target 10 regardless of an operation of the 0th radar 1100 or the third radar 1103. In an embodiment, the radars 1100 to 110n may be clock-based radars. For example, the radars 1100 to 110n may operate based on a plurality of clocks generated based on reference clocks.

The radars 1100 to 110n may generate and radiate transmit pulses 20 to 2n, respectively, to detect the target 10. For example, the 0th radar 1100 may generate the 0th transmit pulse 20 and may radiate the generated 0th transmit pulse 20 to the target 10. Likewise, the first radar 1101 may generate the first transmit pulse 21 and may radiate the generated first transmit pulse 21 to the target 10. The transmit pulses 20 to 2n radiated by the radars 1100 to 110n may reach the target 10 and an echo pulse 30 reflects. Each of the radars 1100 to 110n may generate detection data from the received echo pulse 30, depending on an operation of a clock of the radar.

The arrangement of the radars 1100 to 110n, which is illustrated and described in FIG. 1, is illustrative, and the scope of the present disclosure is not limited thereto. It should be understood that an embodiment in which the radars 1100 to 110n are arranged in any distance or any distribution also belongs to the scope of the present disclosure.

In the above-mentioned radar system 1000, an interference signal from the adjacent radars may be received in each of the radars 1100 to 110n. The interference signal may result in deterioration in detection performance of each of the radars 1100 to 110n and deterioration in detection performance of the radar system 1000. Thus, there is a need for the radar system 1000 in which the interference signal of each of the radars 1100 to 110n is minimized. Hereinafter, a structure and an operation of each of the radars 1100 to 110n, for providing the radar system 1000 in which the interference signal is minimized, and an operation of the radar system 1000 will be described in detail with reference to the drawings.

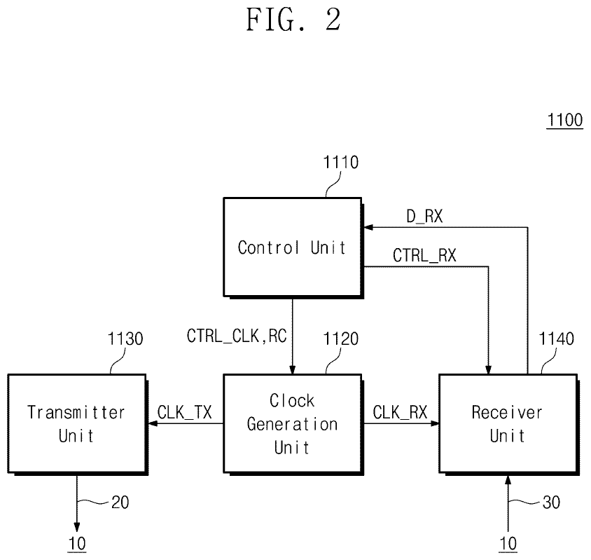

FIG. 2 is a block diagram illustrating in detail a radar 1100 of FIG. 1 according to an embodiment of the present disclosure. Hereinafter, the radar 1100 may correspond to at least one of radars 1100 to 110n of FIG. 1. Referring to FIG. 2, the radar 1100 may include a control unit 1110, a clock generation unit 1120, a transmitter unit 1130, and a receiver unit 1140. The radar according to embodiment of the present disclosure will be described in detail with reference to FIGS. 1 and 2. In an embodiment, the radar 1100 may be a radar which operates based on a clock signal.

The control unit 1110 may control an operation of the radar 1100, based on a control signal. In an embodiment, the control unit 1110 may control the clock generation unit 1120 and the receiver unit 1140, based on control signals. For example, the control unit 1110 may control the clock generation unit 1120 based on a clock generation unit control signal CTRL_CLK and may control the receiver unit 1140 based on a receiver unit control signal CTRL_RX.

In an embodiment, the control unit 1110 may receive data D_RX from the receiver unit 1140. For example, the control unit 1110 may receive the receive data D_RX from the receiver unit 1140 and may transmit detection data generated based on the receive data D_RX to an external device (not shown). In an embodiment, the control unit 1110 may generate a reference clock. For example, the control unit 1110 may generate a reference clock RC and may provide the clock generation unit 1120 with the generated reference clock RC.

The clock generation unit 1120 may generate a clock required for an operation of the radar 1100. In an embodiment, the clock generation unit 1120 may generate clocks, under control of the control unit 1110. For example, the clock generation unit 1120 may generate clock signals, in response to the clock generation unit control signal CTRL_CLK of the control unit 1110. The clock signals may be generated based on the reference clock RC.

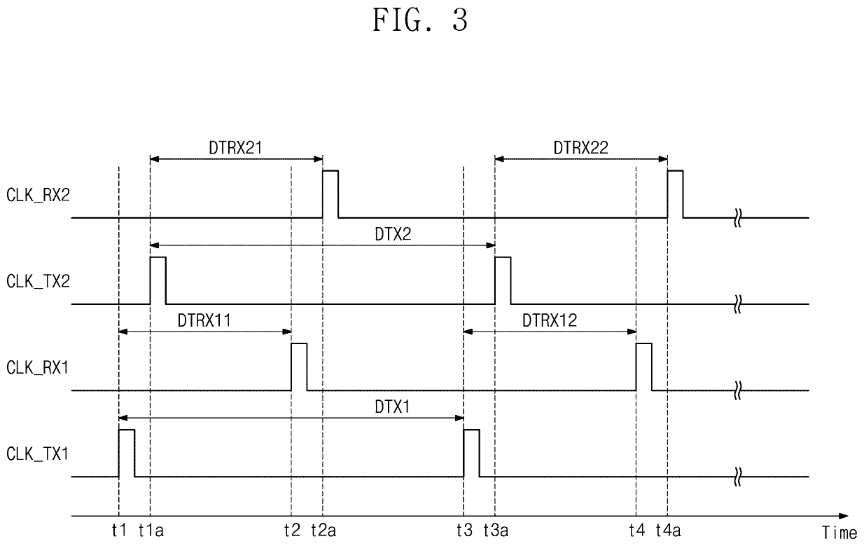

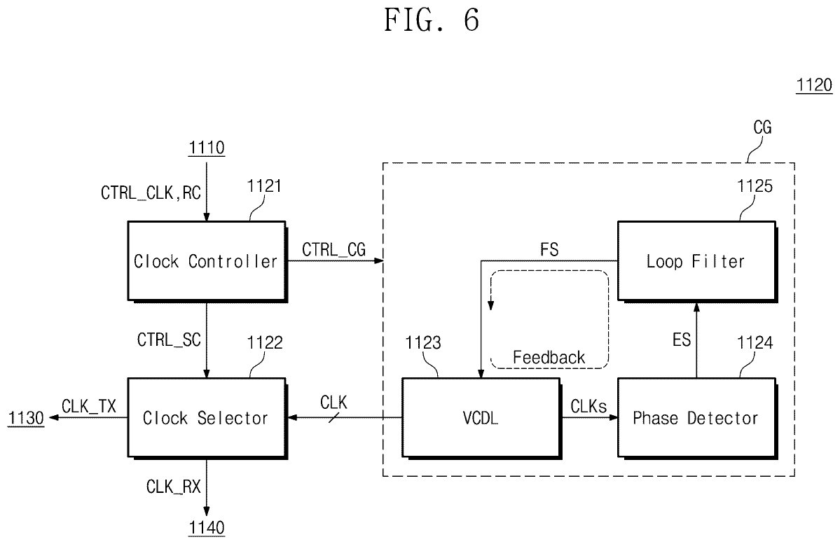

In an embodiment, the clock signals may include a transmission clock signal CLK_TX and a reception clock signal CLK_RX. For example, the clock generation unit 1120 may provide the transmitter unit 1130 with the transmission clock signal CLK_TX and may provide the receiver unit 1140 with the reception clock signal CLK_RX. A more detailed structure and example of the clock generation unit 1120 will be described with reference to FIG. 6, and the transmission clock signal CLK_TX and the reception clock signal CLK_RX will be described in detail with reference to FIGS. 3 to 5.

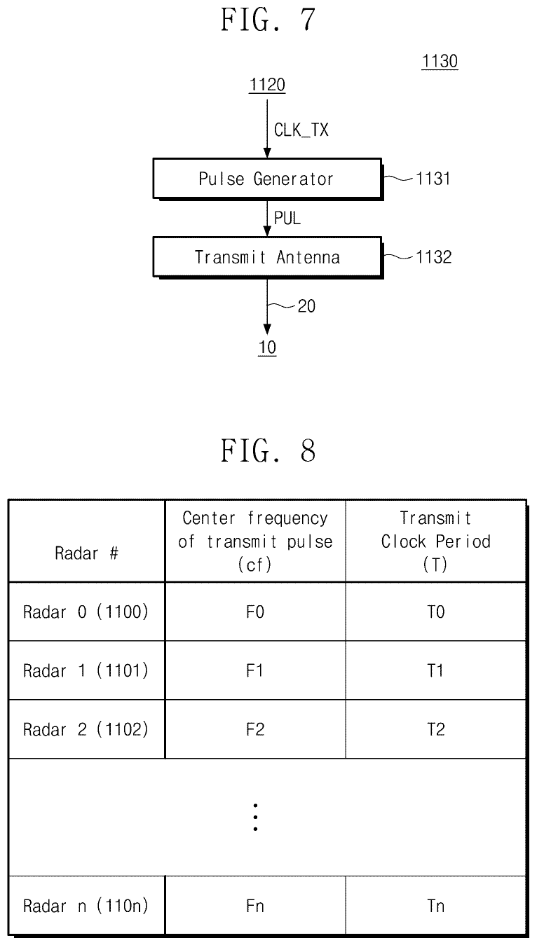

The transmitter unit 1130 may generate a transmit pulse 20. In an embodiment, the transmitter unit 1130 may generate and radiate the transmit pulse 20, in response to the clock signal. For example, the transmitter unit 1130 may generate the transmit pulse 20, in response to the transmission clock signal CLK_TX received from the clock generation unit 1120. The generated transmit pulse 20 may be radiated toward a target 10. A more detailed structure and operation of the transmitter unit 1130 will be described in detail with reference to FIG. 7.

The receiver unit 1140 may generate the receive data D_RX based on an echo pulse 30 received from the target 10. In an embodiment, the receiver unit 1140 may operate, in response to the reception clock signal CLK_RX. For example, the receiver unit 1140 may generate the receive data D_RX from the echo pulse 30 generated from the target 10, in response to the reception clock signal CLK_RX. The receiver unit 1140 may transmit the generated receive data D_RX to the control unit 1110. A more detailed structure and operation of the receiver unit 1140 will be described in detail with reference to FIG. 9.

Referring to FIG. 2, the embodiment in which the radar 1100 includes only the one receiver unit 1140 is illustrated. However, the scope of the present disclosure is not limited thereto. It should be understood that an embodiment of the radar 1100 including two or more receiver units 1140 also belongs to the scope of the present disclosure. For example, the radar 1100 may receive the echo pulse 30, via a receive antenna (e.g., a receive antenna 1141 of FIG. 9) included in each of the plurality of receiver units.

It is illustrated in FIG. 2 that the radar 1100 includes the one transmitter unit 1130 and the one receiver unit 1140, but the scope of the present disclosure is not limited thereto. In an embodiment, the radar 1100 may include the plurality of transmitter units 1130 or the plurality of receiver units 1140.

Hereinafter, an operation in which a radar system 1000 of FIG. 1 may suppress an interference signal between radars 1100 to 110n and may use the radar system 1000 at maximum efficiency will be described, according to an embodiment of the present disclosure, with reference to FIGS. 3 to 5.

FIG. 3 is a graph illustrating a change in clocks generated by each of two radars among radars 1100 to 110n over time, according to an embodiment of the present disclosure. Referring to FIG. 3, changes in first transmission clock signal CLK_TX1, second transmission clock signal CLK_TX2, first reception clock signal CLK_RX1, and second reception clock signal CLK_RX2 over time are illustrated. The horizontal axis of FIG. 3 may indicate time, and the vertical axis may indicate the signal voltage. A first clock CLK1 may indicate or include the first transmission clock signal CLK_TX1 or the first reception clock signal CLK_RX1, and a second clock CLK2 may indicate or include the second transmission clock signal CLK_TX2 or the second reception clock signal CLK_RX2.

The first transmission clock signal CLK_TX1 or the first reception clock signal CLK_RX1 may be a transmission clock signal CLK_TX or a reception clock signal CLK_RX generated by a clock generation unit of any one of radars 1100 to 110n of FIG. 1. The second transmission clock signal CLK_TX2 or the second reception clock signal CLK_RX2 may be a transmission clock signal CLK_TX or the reception clock signal CLK_RX generated by a clock generation unit of any one of the radars 1100 to 110n, which is different from a radar which generates a first clock CLK1 of FIG. 1. A description will be given of an operation and method for detecting a target 10 in a radar system 1000 and a method for avoiding an interference signal in each of radars 1100 to 110n in the radar system 1000.

Referring to FIG. 3, the first transmission clock signal CLK_TX1 may has a first transmit interval DTX1. For example, the first transmission clock signal CLK_TX1 may have a rising edge at a first time point t1 and may similarly have a rising edge at a third time point t3. A time difference between the first time point t1 and the third time point t3 may be the first transmit interval DTX1. A transmitter unit 1130 which operates in response to the first transmission clock signal CLK_TX1 may generate a transmit pulse (e.g., a 0th transmit pulse 20), in response to that the first transmission clock signal CLK_TX1 is the rising edge or the positive edge.

The first reception clock signal CLK_RX1 may have a rising edge after a certain time after the rising edge or the positive edge of the first transmission clock signal CLK_TX1 is generated. For example, the first reception clock signal CLK_RX1 may have a rising edge at a second time point t2 which is a time point after a transmission clock and reception clock signal time difference DTRX11 from the first time point t1. Likewise, the first reception clock signal CLK_RX1 may have a rising edge at a fourth time point t4 which is a time point after a transmission clock and reception clock signal time difference DTRX12 from the third time point t3. A receiver unit 1140 which operates in response to the first reception clock signal CLK_RX1 may generate receive data D_RX from an echo pulse 30, in response to that the first reception clock signal CLK_RX1 is the rising edge or the positive edge.

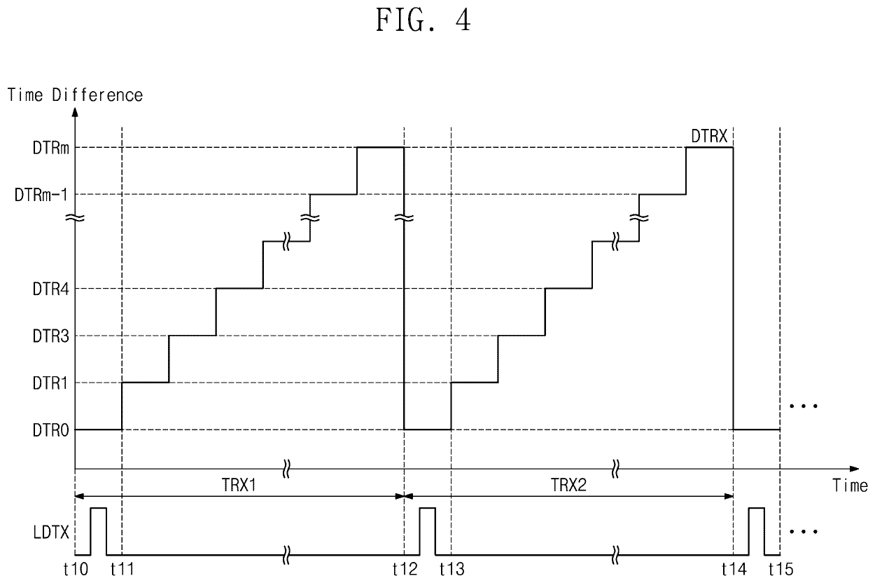

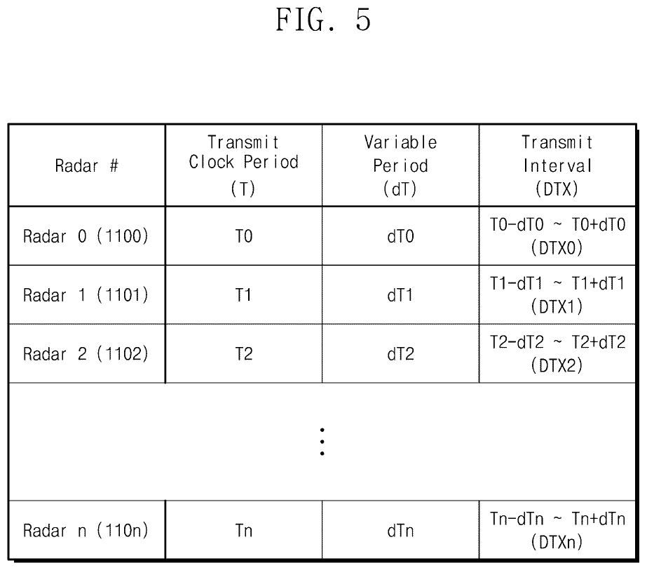

In an embodiment, the first transmit interval DTX1 may be maintained at the same time interval. For example, the first transmit interval DTX1 may correspond to a first period. A transmit interval DTX may indicate or include the first transmit interval DTX1 and a second transmit interval DTX2. The transmit interval DTX will be described in detail with reference to FIG. 5. The 11th transmission clock and reception clock signal time difference DTRX11 and the 12th transmission clock and reception clock signal time difference DTRX12 may be an interval between the rising edge or the positive edge of the first transmission clock signal CLK_TX1 and the rising edge or the positive edge of the first reception clock signal CLK_RX1. A transmission clock and reception clock signal time difference DTRX may indicate or include the 11th transmission clock and reception clock signal time difference DTRX11 and the 12th transmission clock and reception clock signal time difference DTRX12 and a 21st transmission clock and reception clock signal time difference DTRX21 and a 22nd transmission clock and reception clock signal time difference DTRX22, which will be described below. In an embodiment, the transmission clock and reception clock signal time difference DTRX may be used to determine detection distances of radars 1100 to 110n. A more detailed example of the transmission clock and reception clock signal time difference DTRX will be described in detail with reference to FIG. 4.

The second transmission clock signal CLK_TX2 may have the second transmit interval DTX2. In an embodiment, the second transmission clock signal CLK_TX2 may have a rising edge at a time point e which is different from the first transmission clock signal CLK_TX1 edge. For example, the second transmission clock signal CLK_TX2 may have a rising edge at a 1ath time point t1a different from the first time point t1 and may have a rising edge at a 3ath time point t3a different from the third time point t3. An interval between the 1ath time point t1a and the 3ath time point t3a may be the second transmit interval DTX2. The transmitter unit 1130 which operates in response to the second transmission clock signal CLK_TX2 may generate a transmit pulse (e.g., a first transmit pulse 21), in response to that the second transmission clock signal CLK_TX2 is the rising edge or the positive edge.

The second reception clock signal CLK_RX2 may have a rising edge after a certain time after the rising edge or the positive edge of the second transmission clock signal CLK_TX2 is generated. For example, the second reception clock signal CLK_RX2 may have a rising edge at a 2ath time point t2a which is a time point after the 21st transmission clock and reception clock signal time difference DTRX21 from the 1ath time point t1a and is different from the second time point t2. Likewise, the second reception clock signal CLK_RX2 may have a rising edge at a 4ath time point t4a which is a time point after the 22nd transmission clock and reception clock signal time difference DTRX22 from the third time point t3 and is different from the fourth time point t4. The receiver unit 1140 which operates in response to the second reception clock signal CLK_RX2 may generate receive data D_RX from the echo pulse 30, in response to that the second reception clock signal CLK_RX2 is the rising edge or the positive edge.

The details described above are illustrative, and the scope of the present disclosure is not understood as being limited thereto. It should be understood that an embodiment in which the transmitter unit 1130 or the receiver unit 1140 responds to a falling edge or a negative edge also belongs to the scope of the present disclosure. In an embodiment, the transmitter unit 1130 or the receiver unit 1140 may operate, in response to that the first clock CLK1 or the second clock CLK2 is the rising edge or the positive edge or the falling edge or the negative edge.

A radar system 1000 may remove or reduce an interference signal of the radars 1100 to 110n, based on the first clock CLK1 and the second clock CLK2, which are described above. The transmission clock signal of each of the radars 1100 to 110n may fail to be synchronous with the first transmission clock signal CLK_TX1 and the second transmission clock signal CLK_TX2 of FIG. 3 and may reduce an interference signal between the adjacent radars 1100 to 110n. This is because the radars 1100 to 110n are able to receive mutual interference signals, when transmission clock signals are synchronous with each other. Hereinafter, the transmission clock and reception clock signal time difference DTRX or the transmit interval DTX of the radar system 1000 will be described and an operation and a method for removing or reducing a detection range and an interference signal of the radar system 1000 will be described, with reference to FIGS. 4 and 5.

FIG. 4 is a graph illustrating a change in transmission clock and reception clock signal time difference DTRX of FIG. 3 over time, according to an embodiment of the present disclosure. Referring to FIG. 4, a transmission clock and reception clock signal time difference DTRX and a minimum detection distance notification signal LDTX are illustrated. The horizontal axis of FIG. 4 may indicate time, and the vertical axis may indicate the magnitude of the time difference DTR of the transmission clock and reception clock signal DTRX. A description will be given of a process of changing the transmission clock and reception clock signal time difference DTRX and a detection distance in a radar system 1000 with reference to FIGS. 1 to 4.

The transmission clock and reception clock signal time difference DTRX may change at a certain period. The transmission clock and reception clock signal time difference DTRX may have the certain period. In an embodiment, the transmission clock and reception clock signal time difference DTRX may change at the certain period from a minimum time difference to a maximum time difference. For example, referring to FIG. 4, the transmission clock and reception clock signal time difference DTRX may periodically change from a 0th time difference DTR0 to an mth time difference DTRm. For a more detailed example, the transmission clock and reception clock signal time difference DTRX may increase from the 0th time difference DTR0 to the mth time difference DTRm from a 0th time point t10 to a second time point t12 and may similarly increase from the 0th time difference DTR0 to the mth time difference DTRm from the second time point t12 to a fourth time point t14. A first interval TRX1 from the 0th time point t10 to the second time point t12 and a second interval TRX2 from the second time point t12 to the fourth time point t14 may be the same as each other. In an embodiment, the first interval TRX1 and the second interval TRX2 may be a detection period. In another embodiment, the first interval TRX1 or the second interval TRX2 may randomly change, and the first interval TRX1 and the second interval TRX2 may not be the same as each other.

In an embodiment, the time difference of the transmission clock and reception clock signal time difference DTRX may sequentially change in a value between the minimum time difference and the maximum time difference. For example, the time difference of the transmission clock and reception clock signal time difference DTRX may sequentially change from the 0th time difference DTR0 to the mth time difference DTRm. For a more detailed example, the transmission clock and reception clock signal time difference DTRX may have the 0th time difference DTR0 at the 0th time point t10 and may sequentially increase to the first time difference DTR1 and the second time difference DTR2 and may increase to the mth time difference DTRm (hereinafter, where m is any natural number). The change in the transmission clock and reception clock signal time difference DTRX described above is illustrative. It should be understood that an embodiment of changing to any time difference (e.g., randomly) between the 0th time difference DTR0 and the mth time difference DTRm and performing detection at at least one time difference during a pulse repetition period also belongs to the scope of the present disclosure.

As the transmission clock and reception clock signal time difference DTRX increases, the radar system 1000 may detect a farther distance. This is because the transmission clock and reception clock signal time difference DTRX is a time difference between a transmission clock signal CLK_TX and a reception clock signal CLK_RX. They are associated with a time when a transmit pulse 20 returns from a target 10. A detection distance becomes longer as there is an increase in a total time when an echo pulse 30 generated after the transmit pulse 20 reaches the target 10 returns.

In an embodiment, a difference between adjacent time differences DR0 to DRm may correspond to resolution of radars 1100 to 110n of FIG. 2. For example, an interval between the 0th time difference DTR0 and the first time difference DTR1 may be a time difference corresponding to resolution of the radar system 1000. Likewise, an interval between the m-1st time difference DTRm-1 and the mth time difference DTRm may be a time difference corresponding to the resolution of the radar system 1000.

In an embodiment, each of the radars 1100 to 110n may adjust the transmission clock signal CLT_TX and the reception clock signal CLK_RX, depending on the transmission clock and reception clock signal time difference DTRX of FIG. 4. Thus, the radars 1100 to 110n may detect the target 10 from a minimum detection distance to a maximum detection distance. In an embodiment, the radars 1100 to 110n may adjust the 0th time difference DTR0 or the mth time difference DTRm to control the minimum detection distance or the maximum detection distance. Referring to FIG. 4, it is shown that the transmission clock and reception clock signal time difference DTRX increases at equal intervals, but the present disclosure is not limited thereto.

In an embodiment, while the magnitude of the time difference DTR is maintained, a clock generation unit 1120 may generate a plurality of rising edges of the transmission clock signal CLK_TX. In an embodiment, while the first time difference DTR1 is maintained, the clock generation unit 1120 may generate a plurality of rising edges in the transmission clock signal CLK_TX. In an embodiment, the clock generation unit 1120 may generate each of rising edges of the transmission clock signal CLK_TX and a plurality of rising edges of the reception clock signal CLK_RX having the time difference DTR. For example, while the first time difference DTR1 is maintained, the clock generation unit 1120 may generate a plurality of rising edges rising edges of the transmission clock signal CLK_TX and a plurality of rising edges rising edges of the reception clock signal CLK_RX having the first time difference DTR1. A transmitter unit 1130 or a receiver unit 1140 of FIG. 2 may generate the transmit pulse 20, in response to that the respective clocks are rising edges, or may generate receive data D_RX from the echo pulse 30.

When the transmission clock and reception clock signal time difference DTRX is the 0th time difference DTR0 which is the minimum time difference, a minimum detection distance notification signal LDTX may be generated. In an embodiment, the minimum detection distance notification signal LDTX may be generated by the clock generation unit 1120, and the generated minimum detection distance notification signal LDTX may be delivered to a control unit 1110 and the receiver unit 1140. The minimum detection distance notification signal LDTX may be generated at any time point while the transmission clock and reception clock signal time difference DTRX is the 0th time difference DTR0. For example, the minimum detection distance notification signal LDTX may be generated at any time point between the 0th time point t10 and the first time point t11 and may be similarly generated at any time point between the second time point t12 and the third time point t13.

The radar system 1000 may detect the target 10 between the minimum detection distance to the maximum detection distance, based on the above-mentioned embodiments, by means of FIG. 4. In an embodiment, the transmission clock and reception clock signal time differences DTRX of the radars 1100 to 110n may change in the same manner. However, this is illustrative. An embodiment in which the transmission clock and reception clock signal time difference DTRX of each of the radars 1100 to 110n changes in a different manner also belongs to the scope of the present disclosure.

FIG. 5 is a table illustrating in detail a transmit interval DTX of FIG. 3, according to an embodiment of the present disclosure. Referring to FIG. 5, a transmission clock signal period T, a variable period dT, and a transmit interval DTX corresponding to each of radars 1100 to 110n are illustrated. Referring to FIGS. 1, 2, and 5, according to an embodiment of the present disclosure, transmit intervals DTX of the radars 1100 to 110n will be described, and an operation and a method for avoiding an interference signal in each of the radars 1100 to 110n will be described.

Referring to FIGS. 1 and 5 together, each of the radars 1100 to 110n may have the transmission clock signal period T, the variable period dT, and the transmit interval DTX. In an embodiment, the transmit interval DTX of each of the radars 1100 to 110n may be determined based on the transmission clock signal period T and the variable period dT. For example, a 0th transmit interval DTX0 of the 0th radar 1100 may be determined based on a 0th transmission clock signal period T0 and a 0th variable period dT0.

In an embodiment, the transmit interval DTX may be any time interval which is around the transmission clock signal period T and is selected within the range of the variable period dT. For example, a first transmit interval DTX1 of the first radar 1101 may be a time randomly selected between a first time (T1-dT1) obtained by subtracting a first variable period dT1 from a first transmission clock signal period T1 and a second time (T1+dT1) obtained by adding the first variable period dT1 to the first transmission clock signal period T1. Like the first transmit interval DTX1 of the first radar 1101, each of the 0th radar 1100 and the second to nth radars 1102 to 110n may also have the transmit interval DTX.

In an embodiment, all the 0th to nth transmission clock signal periods T0 to Tn may be the same as each other. For example, all the first to nth transmission clock signal periods T1 to Tn may be the same as the 0th transmission clock signal period T0. In this case, all of transmission clock signals of the radars 1100 to 110n may not be synchronous with each other. In an embodiment, at least one of the 0th to nth transmission clock signal periods T0 to Tn may have a value different from another transmission clock signal period. For example, the 0th transmission clock signal period T0 may be the same as the first transmission clock signal period T1 and may be different from the second transmission clock signal period T2. In this case, the 0th to nth transmission clock signal periods T0 to Tn may be set such that all the transmission clock signals of the radars 1100 to 110n are not synchronous with each other. The variable period dT may be a time interval smaller than the transmission clock signal period T.

A radar system 1000 of FIG. 1 may prevent an interference signal between the radars 1100 to 110n in the radar system 1000 from being received, based on the embodiments described with reference to FIGS. 2 to 5. For a more detailed example, as described with reference to FIGS. 4 and 5, each of the radars 1100 to 110n may have the different transmission clock signal period T and may randomly adjust a time when a rising edge of the transmission clock signal CLK_TX is generated, by means of the variable period dT. Thus, the radars 1100 to 110n included in the radar system 1000 may not be synchronous in transmission clock signal CLK_TX with the adjacent radars 1100 to 110n and may not receive an interference signal.

FIG. 6 is a block diagram illustrating in detail a clock generation unit 1120 of FIG. 2, according to an embodiment of the present disclosure. Referring to FIG. 6, the clock generation unit 1120 may include a clock controller 1121, a clock selector 1122, and a clock generator CG. The clock generator CG may include a voltage controlled delay line (VCDL) 1123, a phase detector 1124, and a loop filter 1125. In an embodiment, the clock generation unit 1120 may be implemented as an integrated circuit (IC) (e.g., an application-specific integrated circuit (ASIC), field programmable gate arrays (FPGA), or the like). The clock generation unit 1120 according to an embodiment of the present disclosure will be described in detail with reference to FIG. 6.

The clock controller 1121 may control the overall operation of the clock generation unit 1120. The clock controller 1121 may operate in response to control of a control unit 1110 of FIG. 2. For example, the clock controller 1121 may receive a clock generation unit control signal CTRL_CLK from the control unit 1110 and may control the overall operation of the clock generation unit 1120, based on the received clock generation unit control signal CTRL_CLK. The clock controller 1121 may receive a reference clock RC from the control unit 1110 and may provide the clock generator CG with the received reference clock RC.

In an embodiment, the clock controller 1121 may receive information including timing for generating rising edges rising edges of clocks from the control unit 1110. For example, the clock controller 1121 may receive information including a transmit interval DTX described with reference to FIGS. 3 and 5 or a transmission clock and reception clock signal time difference DTRX described with reference to FIG. 4, a change in the transmission clock and reception clock signal time difference DTRX, and the like from the control unit 1110.

The clock controller 1121 may control the clock selector 1122 and the clock generator CG. In an embodiment, the clock controller 1121 may control the clock selector 1122 and the clock generator CG, based on control signals. For example, the clock controller 1121 may control the clock generator CG, based on a clock generator control signal CTRL_CG and may control the clock selector 1122, based on a selection control signal CTRL_SC.

The clock selector 1122 may select a transmission clock signal CLK_TX or a reception clock signal CLK_RX among a plurality of clocks CLKs. In an embodiment, the clock selector 1122 may operate in response to the selection control signal CTRL_SC. For example, the clock selector 1122 may select the transmission clock signal CLK_TX or the reception clock signal CLK_RX among the clocks CLKs, in response to the selection control signal CTRL_SC. The clock selector 1122 may provide a transmitter unit 1130 with the generated transmission clock signal CLK_TX and may provide the receiver unit 1140 with the generated reception clock signal CLK_RX.

In an embodiment, the selection control signal CTRL_SC may include a transmit interval DTX and a transmission clock and reception clock signal time difference DTRX. For example, the clock selector 1122 may select the transmission clock signal CLK_TX based on information about the transmit interval DTX included in the selection control signal CTRL_SC. The clock selector 1122 may similarly select the reception clock signal CLK_RX based on information about the transmission clock and reception clock signal time difference DTRX included in the selection control signal CTRL_SC.

The clock generator CG may generate the clocks CLKs. For example, the clock generator CG may include a delay locked loop (DLL). The VCDL 1123 may generate a clock signal, in response to a voltage signal. In an embodiment, the VCDL 1123 may generate the clocks CLKs, in response to a clock generator control signal CTRL_CG or a feedback signal FS. In an embodiment, the VCDL 1123 may be composed of multiple stages. For example, the VCDL 1123 may be composed of the multiple stages and may generate clocks, in response to each of several voltages. The VCDL 1123 may provide the clock selector 1122 and the phase detector 1124 with the generated clocks CLKs.

The phase detector 1124 may detect phases of the clocks CLKs. In an embodiment, the phase detector 1124 may generate an error signal ES, based on comparison between the detected phase and the input signal. For example, the phase detector 1124 may detect phase of the clock CLK and may generate the error signal ES, based on comparison with the input signal included in the clock generator control signal CLK_CG. The phase detector 1124 may provide the loop filter 1125 with the generated error signal ES.

The loop filter 1125 may generate the feedback signal FS, based on the error signal ES. The loop filter 1125 may provide the VCDL 1123 with the generated feedback signal FS. The VCDL 1123 may generate the clocks CLKs again, based on the received feedback signal FS. The VCDL 1123, the phase detector 1124, and the loop filter 1125 may perform feedback, based on the above-mentioned operations. The clock generator CG may generate the clocks CLKs corresponding to a plurality of delays, based on the feedback.

FIG. 7 is a block diagram illustrating in detail a transmitter unit 1130 of FIG. 2, according to an embodiment of the present disclosure. Referring to FIG. 7, the transmitter unit 1130 may include a pulse generator 1131 and a transmit antenna 1132. Referring to FIG. 7, the structure of the transmitter unit 1130 according to embodiment of the present disclosure will be described in detail. In an embodiment, the transmitter unit 1130 may be implemented as an integrated circuit (IC) (e.g., an application-specific integrated circuit (ASIC), field programmable gate arrays (FPGA), or the like). For example, the pulse generator 1131 of the transmitter unit 1130 may be implemented as an IC.

The pulse generator 1131 may generate a pulse signal PUL. In an embodiment, the pulse generator 1131 may generate the pulse signal PUL, in response to a transmission clock signal CLK_TX. For example, the pulse generator 1131 may generate the pulse signal PUL, in response to that the transmission clock signal CLK_TX is a rising edge.

In an embodiment, the pulse generator 1131 may include various circuits for generating a pulse. For example, the pulse generator 1131 may include a variable oscillation interval circuit. The variable oscillation interval circuit may be a voltage-controlled oscillator circuit for oscillating during a time corresponding to a variable oscillation interval or may include the voltage-controlled oscillator circuit. The pulse generator 1131 may provide the transmit antenna 1132 with the generated pulse signal PUL.

The transmit antenna 1132 may radiate the transmit pulse 20 to a target 10. In an embodiment, the transmit antenna 1132 may radiate the received pulse signal PUL as the transmit pulse 20. For example, the transmit antenna 1132 may radiate the transmit pulse 20 generated based on the pulse signal PUL received from the pulse generator 1131 to the target 10.

FIG. 7 is illustrated and described on the basis of that the transmitter unit 1130 includes the one transmit antenna 1132, but the scope of the present disclosure is not limited thereto. In an embodiment, the transmitter unit 1130 may include the plurality of transmit antennas 1132. Each transmit antenna 1132 may generate and radiate the transmit pulse 20 based on the pulse signal PUL received from the pulse generator 1131.

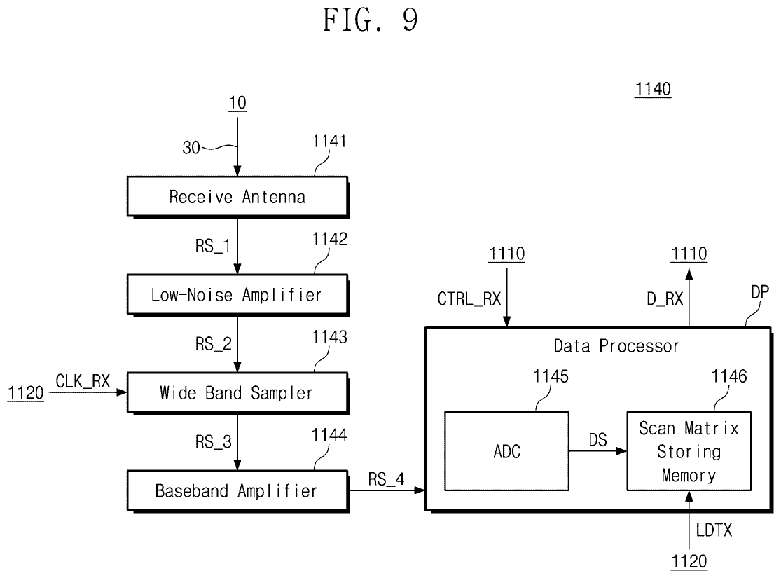

FIG. 8 is a table illustrating a center frequency of a transmit pulse 20 of FIG. 7 of each of radars 1110 to 110n and a period of a transmission clock signal CLK_TX of FIGS. 3 and 5, according to an embodiment of the present disclosure. Referring to FIG. 8, a center frequency of a transmit pulse and a clock period of each of radars 1110 to 110n of FIG. 1 are illustrated. An embodiment of reducing an interference signal of a radar system 1000 of FIG. 1 will be described with reference to FIG. 8.

Referring to FIG. 1 together, as the table shown in FIG. 8, each of the radars 1100 to 110n may generate transmit pulses, each of which has a center frequency fc and has a transmission clock signal period T described with reference to FIG. 5. In an embodiment, the center frequencies fc of the radars 1100 to 110n may be different from each other. For example, a 0th center frequency F0 of the 0th radar 1100 and a first center frequency F1 of the first radar 1101 may be different from each other. Likewise, a second center frequency F2 of the second radar 1102 and a center frequency Fn of the nth radar 110n may be different from each other. A radar system 1000 may make center frequencies of transmit pulses 20 to 2n of the radars 1100 to 110n different from each other, such that interference of the adjacent radars 1100 to 110n is not received or reduced.

As described with reference to FIGS. 3, 5, and 8, by differently setting the center frequency of each of the transmit pulses 20 to 2n, the radar system 1000 may suppress the reception of an interference signal between the adjacent radars 1100 to 110n. It should be understood that embodiments for removing or reducing the reception of the interference signal between the adjacent radars 1100 to 110n of the radar system 1000 of FIG. 1 may be independently executed or may be executed by combining two or more of the embodiments.

FIG. 9 is a block diagram illustrating in detail a receiver unit 1140 of FIG. 2, according to an embodiment of the present disclosure. Referring to FIG. 9, the receiver unit 1140 may include a receive antenna 1141, a low-noise amplifier 1142, a wide band sampler 1143, a baseband amplifier 1144, and a data processor DP. The data processor DP may include an analog-digital converter (ADC) 1145 and a scan matrix storing memory 1146. In an embodiment, the receiver unit 1140 may be implemented as an integrated circuit (IC) (e.g., an application-specific integrated circuit (ASIC), field programmable gate arrays (FPGA), or the like). The receiver unit 1140 according to an embodiment of the present disclosure will be described in detail with reference to FIG. 9.

The receive antenna 1141 may receive and convert an electromagnetic wave into an electrical signal. In an embodiment, the receive antenna 1141 may receive an echo pulse 30 generated from a target 10. For example, the receive antenna 1141 may receive the echo pulse 30 from the target 10 and may provide the low-noise amplifier 1142 with the received echo pulse 30 as a first receive signal RS_1.

FIG. 9 is illustrated and described on the basis of that the receiver unit 1140 includes the one receive antenna 1141, but the scope of the present disclosure is not limited thereto. In an embodiment, the receiver unit 1140 may include the plurality of receive antennas 1141. Each receive antenna 1141 may receive the echo pulse 30 from the target 10 and may generate and provide the first receive signal RS_1 to the low-noise amplifier 1142, based on the received echo pulse 30.

The low-noise amplifier 1142 may amplify only a signal, with low noise. In an embodiment, the low-noise amplifier 1142 may amplify and the receive signal RS_1. For example, the low-noise amplifier 1142 may amplify a signal component of the first receive signal RS_1 and may provide the wide band sampler 1143 with the amplified and generated second receive signal RS_2.

The wide band sampler 1143 may sample a portion of the received signal. In an embodiment, the wide band sampler 1143 may operate in response to a reception clock signal CLK_RX described with reference to FIGS. 2 and 4. For example, the wide band sampler 1143 may sample the second receive signal RS_2, in response to that the received reception clock signal CLK_RX is a rising edge.

The radar 1100 may receive the echo pulse 30 from a detection distance, based on the operation of the wide band sampler 1143. In other words, the radar 1100 may change a detection distance of the radar 1100 based on the operation of the wide band sampler 1143. A transmission clock and reception clock signal time difference DTRX is described with reference to FIGS. 4 and 5 The wide band sampler 1143 may provide the baseband amplifier 1144 with a third receive signal RS_3 generated by sampling the second receive signal RS_2.

The baseband amplifier 1144 may amplify a baseband component of a signal. In an embodiment, the baseband amplifier 1144 may amplify a baseband of the third receive signal RS_3. For example, the baseband amplifier 1144 may provide the data processor DP with a fourth receive signal RS_4 generated by amplifying the baseband of the third receive signal RS_3.

The data processor DP may generate receive data D_RX for the target 10, based on the received fourth receive signal RS_4. In an embodiment, the data processor DP may operate in response to a receiver unit control signal CTRL_RX received from the control unit 1110. For example, the data processor DP may process the fourth receive signal RS_4, in response to the receiver unit control signal CTRL_RX. The data processor DP may include the ADC 1145 and the scan matrix storing memory 1146.

The ADC 1145 may convert an analog signal into a digital signal DS. In an embodiment, the ADC 1145 may convert the fourth receive signal RS_4 in an analog form into the digital signal DS. For example, the ADC 1145 may convert the fourth receive signal RS_4 into the digital signal DS (e.g., depending on the receiver unit control signal CTRL_RX) and may provide the scan matrix storing memory 1146 with the generated digital signal DS or may provide the control unit 1110 with the generated digital signal DS in the form of receive data D_RX.

The ADC 1145 may accumulate the plurality of fourth receive signals RS_4 generated based on the plurality of echo pulses 30 received while a time difference of the transmission clock and reception clock signal time difference DTRX (any one of 0th to mth time differences DTR0 to DTRm of FIG. 4). For example, the ADC 1145 may include registers, a memory element, or the like capable of storing the plurality of fourth receive signals RS_4. In an embodiment, the ADC 1145 may generate a representative digital signal of the plurality of fourth receive signals RS_4. For example, the ADC 1145 may generate the representative digital signal, based on accumulation of the plurality of fourth receive signals RS_4. Like the digital signal DS, the representative digital signal may also be provided to the scan matrix storing memory 1146 or may also be provided to the control unit 1110 in the form of the receive data D_RX.

The scan matrix storing memory 1146 may store the receive data D_RX, based on the received digital signal DS (or the representative digital signal). In an embodiment, the scan matrix storing memory 1146 may operate in response to a minimum detection distance notification signal LDTX. For example, the scan matrix storing memory 1146 may store a scan vector from the digital signal DS (or the representative digital signal), in response to the minimum detection distance notification signal LDTX.

The scan vector may have a plurality of parameters. For example, the scan vector may be a vector, having a single column, row components of which respectively correspond to parameters. In an embodiment, the scan matrix storing memory 1146 may generate a scan matrix, based on a plurality of scan vectors. For example, the scan matrix storing memory 1146 may generate scan vectors or a scan matrix, based on the digital signal DS (or the representative digital signal) of each of the detection distances.

The column of the scan matrix may be associated with a detection distance or a magnitude of a time difference DTR, and the row of the scan matrix may be values of each of a plurality of parameters extracted from a digital signal corresponding to the detection distance or the magnitude of the time difference DTR. The scan vector or the scan matrix may be provided to the control unit 1110 in the form of the receive data D_RX and may include a detection result for the target 10. For example, a first column of the scan matrix may correspond to a first detection distance, and respective rows of the first column may be values of respective parameters of the scan vector corresponding to the first detection distance.

Referring to FIG. 2 together, the scan matrix may be provided to the control unit 1110 in the form of the receive data D_RX. The data processor DP is included in the receiver unit 1140 in the embodiment illustrated and described with reference to FIG. 9, but the scope of the present disclosure is not limited thereto. It should be understood that an embodiment in which the data processor DP is included in one of other components, such as the control unit 1110, or an embodiment in which the data processor DP is included in the radar 1100 also belongs to the scope of the present disclosure.

The radar 1100 described with reference to FIGS. 2 to 9 may control not to receive an interference signal of adjacent radars (e.g., a first radar 1101 or a second radar 1102 of FIG. 1), based on the above-mentioned embodiments. The radar 1100 may perform the above-mentioned operations, in response to control of the control unit 1110. For example, the radar 1100 may adjust the transmission clock signal CLK_TX to prevent an interference signal from being received, such that it is not synchronous with each of clocks of adjacent radars.

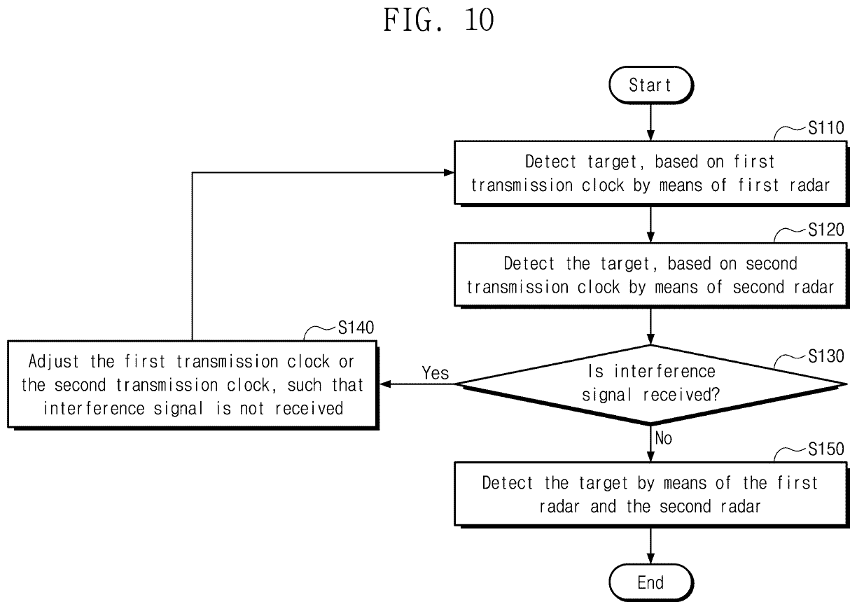

FIG. 10 is a flowchart illustrating an operation method of a radar system 1000 described with reference to FIGS. 1 to 9, according to an embodiment of the present disclosure. An operation method of the radar system 1000 will be described, according to embodiment of the present disclosure, with reference to FIGS. 1 and 10.

In operation S110, the radar system 1000 may detect a target, based on a first transmission clock signal by means of (or, by using) a first radar. The first radar may be any one of radars 1100 to 110n of FIG. 1. For example, the radar system 1000 may detect a target 10, based on the first transmission clock signal by means of a first radar 1101 of FIG. 1. In detail, the first radar 1101 may radiate a transmit pulse 20, in response to that the first transmission clock signal is a rising edge and may generate a rising edge of a reception clock signal to correspond to a detection distance, thus receiving an echo pulse 30 and detecting the target 10.

In operation S120, the radar system 1000 may detect the target, based on a second transmission clock signal by means of (or, by using) a second radar. The second radar may be a radar different from the first radar, which may be any one of the radars 1100 to 110n of FIG. 1. The second radar may operate like the first radar. For example, the second radar may detect the target 10, based on a second transmission clock signal and a reception clock signal corresponding to the second transmission clock signal.

The first radar and the second radar are described as an example of being used as single radars, but the present disclosure is not limited thereto. It should be understood that an embodiment in which a plurality of radars detect the target based on respective transmission clock signals in operation S110, an embodiment in which the plurality of radars detect the target based on respective transmission clock signals in operation S120, or an embodiment in which the plurality of radars detect the target based on respective transmission clock signals in the two operations also belongs to the scope of the present disclosure.

In operation S130, the radar system 1000 may verify whether an interference signal between the radars 1100 to 110n is received. When the interference signal is received, the radar system 1000 may move to operation S140. Conversely, when the interference signal is not received, the radar system 1000 may move to operation S150.

In operation S140, a first radar or a second radar may adjust a first transmission clock signal or a second transmission clock signal, such that the interference signal is not received. In an embodiment, the first transmission clock signal or the second transmission clock signal may be adjusted not to be synchronous with each other, depending on the embodiment described with reference to FIGS. 3 and 5. In another embodiment, as described with reference to FIG. 8, the radar system 1000 may adjust center frequencies of transmit pulses of the first radar and the second radar not to overlap with each other.

When using the plurality of radars in operation S110 or S120, the radar system 1000 may adjust respective transmission clock signals depending on the above-mentioned embodiments such that the interference signal is not received in all the plurality of radars. Furthermore, an embodiment in which the radar system 1000 causes transmission clock signals not to be synchronous with each other and makes center frequencies of transmit pulses different from each other to remove an interference signal may also belong to the scope of the present disclosure. After operation S140, the radar system 1000 may return to operation S110 again.

In operation S150, the radar system 1000 may detect the target 10, using each of the radars 1100 to 110n. Each of the radars 1100 to 110n may detect the target 10, without receiving interference signals, based on the method described with reference to FIGS. 3, 5, and 8. In an embodiment, each of the radars 1100 to 110n of the radar system 1000 may detect the target 10 from a minimum detection distance to a maximum detection distance based on the embodiment described with reference to FIGS. 4 and 5. Each of the radars 1100 to 110n in the radar system 1000 may detect the target 10, based on the embodiment described with reference to FIGS. 6, 7, and 9.

According to an embodiment of the present disclosure, the radar system and the operation method thereof may be provided to minimize interference between multiple radars and optimize the detection performance of an individual radar of the radar system.

The above-mentioned contents are detailed embodiments for executing the present disclosure. The present disclosure may also include embodiments which are simply changed in design or are easily changed, as well as the embodiments described above. Furthermore, the present disclosure may include technologies capable of being easily modified and executed using embodiments. Accordingly, the scope of the present disclosure should not be limited to the above-described embodiments, but should be determined by equivalents to the claims of the present disclosure as well as the claims described later.

What is claimed is:

1. A radar system comprising:
a first radar configured to generate a first transmit pulse in response to a first transmission clock signal and detect a target in response to a first reception clock signal with a first transmission clock and reception clock signal time difference according to a first detection distance; and
a second radar configured to generate a second transmit pulse in response to a second transmission clock signal and detect the target in response to a second reception clock signal with a second transmission clock and reception clock signal time difference according to a second detection distance,
wherein the first transmission clock signal and the second transmission clock signal are not synchronous with each other, and
wherein the first radar generates a minimum detection distance notification signal, when the first detection distance is at the minimum detection distance of the first radar.

2. The radar system of claim 1, further comprising:
a third radar configured to generate a third transmit pulse in response to a third transmission clock signal and detect the target in response to a third reception clock signal with a third transmission clock and reception clock signal time difference according to a third detection distance,
wherein the third transmission clock signal is not synchronous with the first transmission clock signal and the second transmission clock signal.

3. The radar system of claim 1, wherein a first center frequency of the first transmit pulse and a second center frequency of the second transmit pulse are different from each other.

4. The radar system of claim 1, wherein the first transmission clock signal includes a first rising edge and a second rising edge and an interval between the first rising edge and the second rising edge is any interval between a first interval and a second interval, and
wherein the second transmission clock signal includes a third rising edge and a fourth rising edge and an interval between the third rising edge and the fourth rising edge is any interval between a third interval and a fourth interval.

5. The radar system of claim 1, wherein the first detection distance is a distance between a minimum detection distance and a maximum detection distance of the radar system, and
wherein the second detection distance is a distance between the minimum detection distance and the maximum detection distance of the radar system.

6. The radar system of claim 1, wherein the first radar includes a receiver unit, and
wherein the receiver unit includes:
a receive antenna configured to receive an echo signal generated after the transmit pulse is reflected from the target;
a low-noise amplifier configured to amplify the echo signal to generate a first receive signal;
a wide band sampler configured to receive the first receive signal and sample the first receive signal in response to a reception clock signal to generate a second receive signal; and
a data processor configured to generate receive data, based on the second receive signal.

7. The radar system of claim 4, wherein the first interval and the second interval are generated based on a first period and a first variable period,
wherein the third interval and the fourth interval are generated based on a second period and a second variable period,
wherein the first interval is a value obtained by subtracting the first variable period from the first period,
wherein the second interval is a value obtained by adding the first variable period to the first period,
wherein the third interval is a value obtained by subtracting the second variable period from the second period, and
wherein the fourth interval is a value obtained by adding the second variable period to the second period.

8. The radar system of claim 6, wherein the receiver unit further includes a baseband amplifier configured to amplify a baseband of the second receive signal to generate a third receive signal,
wherein the data processor includes:
an analog-digital converter (ADC) configured to convert the third receive signal into a digital signal; and
a scan matrix storing memory configured to store a scan vector based on the digital signal and generate a scan matrix based on the scan vector, and
wherein the scan matrix represents the receive data.

9. The radar system of claim 8, wherein the scan vector and the scan matrix are generated in response to the minimum detection distance notification.

10. An operation method of a radar system for detecting a target, the operation method comprising:
detecting the target by means of a first radar based on a first transmission clock signal;
detecting the target by means of a second radar based on a second transmission clock signal; and
detecting the target from a minimum detection distance of each of the first radar and the second radar to a maximum detection distance of each of the first radar and the second radar, by means of the first radar and the second radar,
wherein the first transmission clock signal and the second transmission clock signal are not synchronous with each other.

11. The operation method of claim 10, wherein the first radar detects the target in response to the first transmission clock signal and a first reception clock signal with a first transmission clock and reception clock signal time difference according to a first detection distance, and
wherein the second radar detects the target in response to the second transmission clock signal and a second reception clock signal with a second transmission clock and reception clock signal time difference according to a second detection distance.

12. The operation method of claim 10, wherein the first transmission clock signal includes a first rising edge and a second rising edge and an interval between the first rising edge and the second rising edge is any interval between a first interval and a second interval, and
wherein the second transmission clock signal includes a third rising edge and a fourth rising edge and an interval between the third rising edge and the fourth rising edge is any interval between a third interval and a fourth interval.

13. The operation method of claim 12, wherein the first interval and the second interval are generated based on a first period and a first variable period,
wherein the third interval and the fourth interval are generated based on a second period and a second variable period,
wherein the first interval is a value obtained by subtracting the first variable period from the first period,
wherein the second interval is a value obtained by adding the first variable period to the first period,
wherein the third interval is a value obtained by subtracting the second variable period from the second period, and
wherein the fourth interval is a value obtained by adding the second variable period to the second period.

14. A radar configured to detect a target, the radar comprising:
a control unit configured to control an operation of the radar;
a transmitter unit configured to radiate a transmit pulse to the target, in response to a transmission clock signal;
a receiver unit configured to receive an echo signal reflected from the target in response to a reception clock signal and generate detection data; and
a clock generation unit configured to generate the transmission clock signal and the reception clock signal,
wherein the transmission clock signal includes a first rising edge and a second rising edge, and
wherein an interval between the first rising edge and the second rising edge is a first interval obtained by subtracting a first variable period from a first period to a second interval obtained by adding the first variable period to the first period.
